(19) United States
(12) Patent Application Publication
(10) Pub. No.: US 2026/0241598 A1
(43) Pub. Date: Aug. 20, 2026

(54) METHOD FOR CONTROLLING A SLICING MACHINE AND SLICING MACHINE

(71) Applicant: MULTIVAC SEPP HAGGENMÜLLER SE & CO. KG, Wolfertschwenden (DE)

(72) Inventor: Manuel MÖSLE, Altusried (DE)

(73) Assignee: MULTIVAC SEPP HAGGENMÜLLER SE & CO. KG, Wolfertschwenden (DE)

(21) Appl. No.: 19/545,376

(22) Filed: Feb. 20, 2026

(30) Foreign Application Priority Data
Feb. 20, 2025 (DE) 102025106406.7

(51) Int. Cl. B26D 5/00; B26D 3/16; B26D 7/34

(52) U.S. Cl. CPC B26D 5/00; B26D 3/16; B26D 7/34; B26D 2210/02

(57) ABSTRACT

The disclosure relates to a method for operating a slicing machine for slicing at least one product caliber into slices, comprising: feeding the at least one product caliber along a feed direction to a slicing unit; slicing, by the slicing unit, the at least one product caliber into slices; and discharging, by at least one valve of a spraying device of the slicing machine, a spraying agent towards the at least one product caliber and/or onto at least one of the sliced slices, wherein the discharging of the spraying agent is caused by an opening signal sent by a control unit of the slicing machine to the spraying device. The method further comprises sending a pre-opening signal, by the control unit, to the spraying device, before the opening signal, wherein the pre-opening signal itself does not yet cause any discharge of spraying agent by the spraying device.

### CROSS-REFERENCE TO RELATED APPLICATIONS

This application claims foreign priority benefits under 35 U.S.C. § 119(a)-(d) to German patent application number DE 102025106406.7, filed February 20, 2025, which is incorporated by reference in its entirety.

### SUMMARY

The disclosure relates to a method for controlling a slicing machine for slicing at least one product caliber into slices, comprising the following steps:

feeding, by means of a feeding unit of the slicing machine, the at least one product caliber along a feed direction to a cutting device of the slicing machine,

slicing, by means of a slicing unit, the at least one product caliber into slices, and

discharging, by means of at least one valve of a spraying device of the slicing machine, a spraying agent towards the at least one product caliber and/or onto at least one of the sliced slices, wherein the discharging of the spraying agent is caused by means of an opening signal which is sent by a control unit of the slicing machine to the spraying device.

The disclosure further relates to a slicing machine.

At this point, it should already be noted that the method and/or the slicing machine according to the disclosure is intended to slice product calibers into slices, preferably from foodstuffs like meat, sausages, cheese or the like. The slicing unit can comprise a knife which can be movable in a slicing plane. For example, the knife can be rotatably driven about a rotational axis. By means of the knife, the slices can be separated from an end of the at least on product caliber facing the slicing unit.

All this also applies to the method according to the disclosure and/or the slicing machine according to the disclosure.

For known slicing machines with spraying devices, which are generally equipped with at least one valve, the problem lies in the fact that more spraying agent, which can comprise, for example, a release agent, is discharged onto the sliced slices than desired, which leads to contamination of the respective slicing machine as well as to unsatisfactory product quality. The cause of excessive discharge of spraying agent often lies in the fact that valves comprise a certain inertia, that is, a predetermined period of time regularly elapses before a valve discharges spraying agent after having received an opening signal.

If a discharge of a spraying agent is thus to be controlled precisely in respect of a discharge time and/or discharge quantity, this regularly constitutes a technical challenge. An excessive discharge of spraying agent also leads not only to an increased contamination of the slicing machine itself, but also an excessively high consumption of resources.

Therefore, it is an object of the disclosure to provide a solution thereto.

This object is achieved according to the disclosure by a method of the type mentioned at the outset, which comprises further: sending a pre-opening signal, by the control unit, to the spraying device, which is sent before the opening signal, wherein the pre-opening signal itself does not yet cause any discharge of spraying agent by the spraying device.

The pre-opening signal sent according to the disclosure can cause at least one valve of the spraying device to be actuated before the actual opening signal is sent. Consequently, the at least one valve can be opened with a very short response time when the opening signal is delivered, and preferably closed again, so that a spray burst discharged by the spraying device, for example with respect to a start and/or end time and/or a spray duration and/or a spray quantity, can be controlled with very high precision. For example, the pre-opening signal can already act on a predetermined force act on a closure body of the valve or the like, which is, however, chosen to be at most such that a threshold that would cause an opening movement of the closure body and thus discharge of the spraying agent by the valve is not yet exceeded. After the delivery of the pre- opening signal follows according to the disclosure the delivery of the opening signal which causes the discharge of the, for example liquid, spraying agent.

The pre-opening signal can be preferably sent immediately before the opening signal or the pre-opening signal is sent with a predetermined time offset before the opening signal, wherein the predetermined time offset may lie, preferably, in a range of 1 ms to 0.05 ms, particularly preferably in a range of 0.1 ms to 0.05 ms. Accordingly, the pre-opening signal and the opening signal can be sent one immediately after the other, essentially without any time offset, or sequentially with a predetermined time offset controlled by the control unit.

If the valve is an electrically actuated valve, the pre-opening signal is preferably a voltage signal, which has a predetermined pre-opening voltage. The pre-opening voltage is preferably smaller than the predetermined opening voltage of the valve. Alternatively, the pre-opening valve can be higher than the opening voltage, in particular, when the pre-opening signal has such a short signal duration that, despite the higher pre-opening voltage, the pre-opening signal does not yet cause the valve to open, for example due to inertia effects on the valve.

Accordingly, according to a preferred further development of the last-mentioned embodiment, the opening signal can be a further voltage signal, which has a predetermined opening voltage, which is preferably higher or lower than the pre-opening voltage.

In this case, the pre-opening voltage can, for example, be at most half of the predetermined opening voltage. Alternatively, the pre-opening voltage can be at least twice of the predetermined opening voltage.

In a preferred embodiment, the pre-opening voltage can be about 12V and the opening voltage about 24V, or vice-versa.

According to an embodiment, the pre-opening signal can be a continuous signal, in particular a voltage signal. The pre-opening signal can have, for example, a length of 2000 ms, preferably at most 100 ms. The pre-opening signal can be a permanent signal. Accordingly, the pre-opening signal can, if desired, be applied continuously, but without opening the valve.

According to another embodiment, the pre-opening signal is a pulse-like signal, in particular a voltage signal, which has one or more signal pulses. The signal pulses can each have the same or at least partially different pulse durations. Each signal pulse can have, for example, a length of at most 2 ms, preferably at most 1 ms. It is also fundamentally conceivable to have combinations in which a pre-opening signal is partly of continuous form and partly of pulse-like form.

According to a preferred embodiment, the at least one valve can comprise a solenoid valve. Accordingly, a biasing of the at least one valve can be achieved by the pre-opening signal which sequentially leads to a faster reaction, that is the opening, of the solenoid valve when the opening signal is sent.

In order to prevent adhesion or sticking of slices lying on top of each other, which are portioned after slicing into portions of several slices, for example shredded or stacked, the spraying agent can include a release agent.

In order to ensure that only as much spraying agent as necessary is discharged, the actual valve opening time should be as short as possible. That is why it is recommended that the opening time of the at least one valve for discharging a spray burst of the spraying agent is at most 7 ms, preferably at most 5 ms, particularly preferably at most 3 ms.

According to another aspect of the disclosure, the above object is achieved by a slicing machine for slicing at least one product caliber into slices, wherein the slicing machine is preferably adapted and designed to perform the above-described method according to the disclosure, wherein the slicing machine comprises: a feeding unit, which is configured to feed at least one product caliber along a feed direction to a slicing unit of the slicing machine, the slicing unit which is configured to slice at least one product caliber into slices, a spraying device with at least one valve, which is configured to discharge a spraying agent towards the at least one product caliber and/or onto at least one of the sliced slices, and a control unit which is in signal connection with at least the spraying device and configured to send an opening signal to the spraying device, wherein the discharge of the spraying agent is caused, wherein the control unit is further configured to send a pre-opening signal to the spraying device before the opening signal, wherein the pre-opening signal itself does not lead yet to any discharge of spraying agent by the spraying device.

With regard to the advantages and effects of the slicing machine according to the disclosure, reference is made to the advantages and effects of the method according to the disclosure. All features, effects and advantages described for the method according to the disclosure also apply to the slicing machine according to the disclosure and vice versa.

Preferably, the spraying machine is arranged such that the at least one valve is oriented with respect to a discharge direction of the spraying agent, towards the slicing unit, that is, towards the at least one product caliber, or towards a portioning unit of the slicing machine. The discharge direction can be further set by a pivoting arrangement of the at least one valve of the slicing machine. Furthermore, the spraying device can be arranged in a feed direction downstream of the slicing unit.

It should be further noted that the slicing machine can comprise further a portioning unit, for example in the form of one or more portioning belts, which is configured to form portions of the slices cut by the slicing machine and to discharge the portions along a discharge direction. Each portion can further include one or several slices.

### BRIEF DESCRIPTION OF THE DRAWINGS

Embodiments according to the disclosure will be explained in more detail below with reference to the accompanying drawings:

FIG. 1a is a schematic side view of a slicing machine according to the disclosure, according to one embodiment;

FIG. 1b is a schematic side view of a slicing machine according to the disclosure, according to a further embodiment, with a spraying device modified relative to FIG. 1a;

FIG. 2a is a schematic axis diagram which illustrates a sequence of a pre-opening signal and an opening signal; and

FIG. 2b is another schematic axis diagram which illustrates another example of a pre-opening signal and an opening signal.

### DETAILED DESCRIPTION

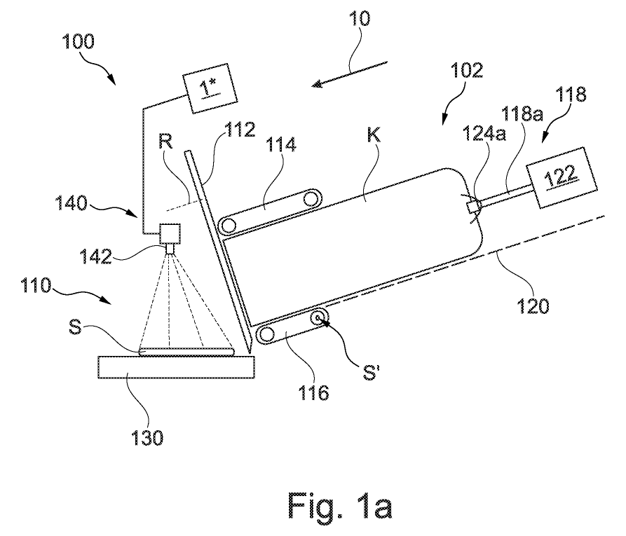

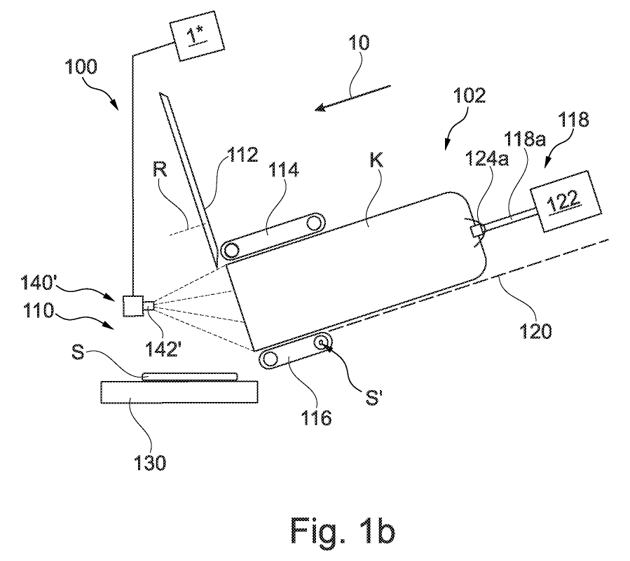

In FIG. 1a, a slicing machine according to the disclosure is shown schematically in a side view according to one embodiment and is generally designated by reference numeral 100.

The slicing machine 100 can be configured as a single-lane or multi-lane slicing machine, wherein, in the side view according to FIG. 1a, only an outermost lane of the slicing machine 100 is visible.

The slicing machine 100 comprises a feeding unit 102, which is configured to feed a product caliber K along a feed direction 10 to a slicing device 110. The slicing device 110 may include a knife 112, which can be driven to rotate about an axis of rotation R, for example, by means of an electric drive unit (not shown). The knife 112, for example, can be designed as a sickle knife, which preferably has a radius that varies around the rotation axis R, especially increasing in the direction of rotation around the rotation axis R. Consequently, the knife 112 can initially release a cutting gap with a partial rotation around the rotation axis R, allowing the product caliber K to advance in the feed direction 10, and with a further rotation around the rotation axis R, separate a slice S at a time from the product caliber K. The slices S can then fall onto a portioning unit 130. For example, by stacking or shingling multiple slices S, respective portions can be formed on the portioning unit 130. From there, the portions can be conveyed to a (not shown here) insertion unit, for example in the form of a belt inserter or the like, which may be configured to supply the portions to a downstream processing device, for example in the form of a packaging machine or the like, which is likewise not illustrated herein.

At a front end, the at least one product caliber K can be guided by an upper traction belt 114 and/or a lower traction belt 116. The upper traction belt 114 and/or the lower traction belt 116 can be driven separately. However, it is generally sufficient if at least one of the upper traction belt 114 and the lower traction belt 116 can be driven in a circulating manner in and preferably against the feed direction 10. In the illustrated embodiment the traction belt 116 can, for example, be pivotable about a pivot axis S′, so that it can be swung up during loading of the slicing machine 100 to serve as a stop for the at least one product caliber K when it is gripped by a gripping unit 118.

Moreover, the slicing machine 100 may include a gripping unit 118 with at least one gripper 118a, which can be configured to grip the product caliber K at an end facing away from the slicing unit 110. In the present embodiment the gripping unit 118 comprises at least one gripper 118a, wherein, in the case of a more multi-lane slicing machine, a further gripper configured correspondingly to the gripper 118a can be provided for each lane. The gripper 118a or the grippers can be arranged at the common gripper carriage 122. Further, a detection sensor 124a can be associated to the gripper 118a, as well as optional to any other gripper, which, for example, is configured to detect when the gripper 118a contacts the product caliber K.

Before and during the slicing, the product caliber K can rest on a feeder 120, which may be designed as a belt conveyor and is only depicted schematically in FIG. 1a.

Furthermore, in FIG. 1a, a control unit 1* of the slicing machine 100 is schematically indicated, by means of which the slicing unit 110 and the feeding unit 102 of the slicing machine 100, as well as preferably all other movable parts of the slicing machine 100, can be controlled. The upper traction belt 114, the lower traction belt 116, the feeder 120, and the gripping unit 118 can be associated with the feeding unit 102.

As one skilled in the art would understand, the control unit 1*, as well an any other unit, device, component, system, subsystem, arrangement, or the like described herein may individually, collectively, or in any combination comprise appropriate circuitry, such as one or more appropriately programmed processors (e.g. one or more microprocessors including central processing units (CPU)) and associated memory, which may include stored operating system software and/or application software executable by the processor(s) for controlling operation thereof and/or for performing the particular algorithms represented by the various functions and/or operations described herein. One or more of such processors, as well as other circuitry and/or hardware, may be included in a single ASIC (Application-Specific Integrated Circuitry), or several processors and various circuitry and/or hardware may be distributed among several separate components, whether individually packaged or assembled into a SoC (System-on-a-Chip).

A particularity of the slicing machine 100 according to the disclosure lies in the fact that this further comprises a spraying device 140 with at least one valve 142, which is configured to discharge a spraying agent, like a fluid release agent or the like, onto at least some of the sliced slices S. According to the illustrated embodiment, the spraying device 140 is arranged on the frame of the slicing machine 100 (not shown) so that the at least one valve 142 is oriented in respect to a discharge direction of the spraying agent towards a portioning unit 130. According to an alternative embodiment, the spraying device 140, in particular the at least one valve 142, can be configured so that it is arranged in regard to the discharge direction of the spraying device towards the slicing unit 110, in particular towards the knife 112. Further the spraying device 140 or the at least one valve 142 can be pivotable around at least one pivot axis in order to be able to vary the discharge direction accordingly. The supply of the at least one valve 142 with spraying agent can comprise the spraying device 140, a spraying agent tank or the like, which can be in fluid communication with the at least one valve 142, however, is not illustrated in FIG. 1a because of clarity reasons. The spraying agent tank can be arranged on or nearby the slicing machine 100.

As further shown schematically in FIG. 1a, the spraying device 140 is in signal communication with the control unit 1* in order to be able to receive corresponding signals from the control unit 1* for actuating the spraying device 142. According to the disclosure, the control unit 1* is further configured to send a pre-opening signal before the opening signal to the spraying device 140, wherein the pre-opening signal itself does not yet cause any discharge of spraying agent by the spraying device 140.

FIG. 1b shows an embodiment of a slicing machine according to the disclosure that is slightly modified compared with FIG. 1a and is identical in large parts to the slicing machine 100 according to FIG. 1a for which reason corresponding reference numerals are used and identical components are not described again here. The slicing machine 100 according to FIG. 1b, however, comprises an alternatively designed spraying device 140' with at least one valve 142', which is configured to discharge spraying agent towards the at least one product caliber K so that one slice S can already be sprayed with spraying agent before it is cut off from a respective product caliber K. The knife 112, which is designed as a sickle knife, is therefore shown in FIG. 1b in a position rotated about the rotational axis R relative to FIG. 1a, in which the product caliber K is not obscured by the knife 112.

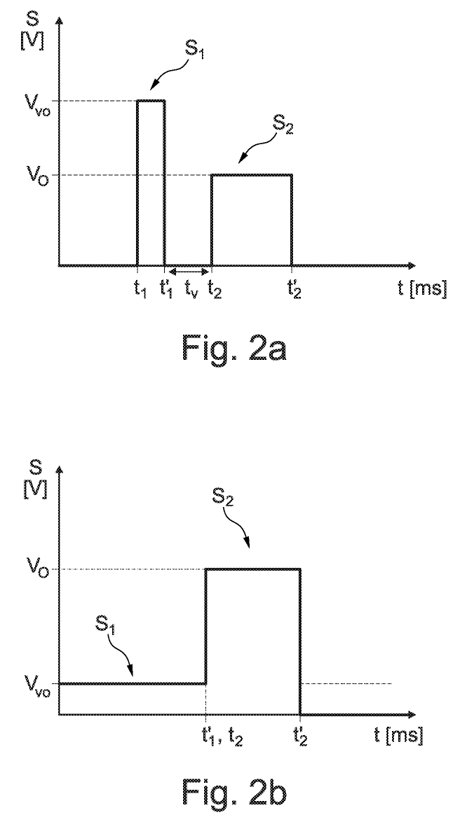

In FIG. 2a, which illustrates a schematic axis diagram, an exemplary course for the pre-opening signal S₁ and the opening signal S₂ like the temporal context is shown. The axis diagram comprises herein a time axis t which can, for example, indicate a time in milliseconds (ms), as well as a further axis s, which can, for example, indicate a voltage of a respective signal. Alternatively, in addition to the voltage, the current of the respective signals can obviously also be varied. If spraying agent should be discharged by the spraying device 140 according to the disclosure, the control unit 1* sends first the pre-opening signal S₁, which comprises in the herein illustrated embodiment a pre-opening voltage Vᵥₒ, to the spraying device 140. The pre-opening signal S₁ herein extends over the time period t₁ to t'₁. After the discharge of the pre-opening signal S₁, a time offset tᵥ occurs in the illustrated embodiment, where no signal from the control unit 1* is delivered. After the time offset tᵥ has elapsed, at time t₂ the actual opening signal S₂ is delivered, which comprises the voltage Vₒ. If the at least one valve 142 is, for example, a solenoid valve, the delivery of the pre-opening signal S₁ can already achieve a pre-magnetization of the at least one valve 142, so that the valve 142 can be opened more quickly and thus also more precisely upon delivery of the opening signal S₂. The pre-opening signal S₁is chosen in terms of time to be short enough that it is still insufficient to open the at least one valve 142. It should, however, be noted that the illustrated temporal relationships are merely schematic in nature and that the pre-opening signal S₁ can also be significantly shorter in relation to the opening signal S₂. It is also not necessary for a time offset tᵥ to exist between the pre-opening signal S₁ and the opening signal S₂; rather, the signals S₁ and S₂ can also be sent consecutively by the control unit 1*, that is, immediately one after the other without any time offset therebetween. Furthermore, also in the embodiment depicted in FIG. 2a, the pre-opening voltage Vᵥₒ may be lower than or equal to the opening voltage Vₒ.

In FIG. 2b an alternative embodiment for the pre-opening signal S₁and the opening signal S₂ is shown. Instead of the pulse-like pre-opening signal, as shown in FIG. 2a, the control unit 1* can also be configured to send a continuous pre-opening signal S₁, as shown in FIG. 2b. The continuous, that is the permanent pre-opening signal S₁ has herein preferably a pre-opening voltage Vᵥₒ which is comparatively low but chosen to be at most such that it is still insufficient to open the at least one valve 142. As soon as, in the embodiment shown in FIG. 2b, spraying agent is to be discharged through the at least one valve 142, the opening signal S₂ is added to the pre-opening signal S₁ at time t'₁ or t₂, which ultimately results in the opening of the at least one valve 142 and thus in the delivery of spraying agent. At time t'₂, when the discharge of spraying agent through the at least one valve 142 is to be stopped, the signal voltage can either return to 0, that is, the signal output by the control unit 1* is stopped, or the pre-opening signal S₁can continue to be applied, as indicated in FIG. 2b by a dashed line from time t'₂ onwards.

It should further be noted that the pre-opening voltage Vᵥₒ can be approximately 12 V or less and the opening voltage can be approximately 24 V, which can correspond, in principle, to the example shown in FIG. 2b. Alternatively, the pre-opening voltage Vᵥₒ can be approximately 24 V or more, and the opening voltage Vₒ can be only approximately 12 V, which can, for example, apply to the embodiment shown in FIG. 2a. In such a case, as shown in FIG. 2a, it must be ensured, however, that the pre-opening signal S₁ is correspondingly short. In such a case, it must also be ensured that the opening signal S₂ has a sufficient voltage to still open the at least one valve 142. The numerical values for the voltages mentioned herein are merely exemplary and can vary arbitrarily depending on the application without departing from the scope of the present disclosure.

Finally, it should be noted that the illustrated signal profiles of the opening signals and pre-opening signals do not necessarily have to be of rectangular shape, and signal profiles that deviate from rectangular signals are also conceivable.

What is claimed is:

1. A method for operating a slicing machine for slicing at least one product caliber into slices, comprising:
feeding, by a feeding unit of the slicing machine, the at least one product caliber along a feed direction to a slicing unit of the slicing machine;
slicing, by the slicing unit, the at least one product caliber into slices; and
discharging, by at least one valve of a spraying device of the slicing machine, a spraying agent towards the at least one product caliber and/or onto at least one of the sliced slices, wherein the discharging of the spraying agent is caused by an opening signal which is sent from a control unit of the slicing machine to the spraying device;
wherein the method further comprises sending a pre-opening signal, by the control unit, to the spraying device, which is sent before the opening signal, and wherein the pre-opening signal itself does not yet cause any discharge of spraying agent by the spraying device.

2. The method according to claim 1, wherein the pre-opening signal is sent immediately before the opening signal or the pre-opening signal is sent with a predetermined time offset before the opening signal.

3. The method according to claim 2, wherein the predetermined time offset is in a range of 1 ms to 0.05 ms.

4. The method according to claim 2, wherein the predetermined time offset is in a range of 0.1 ms to 0.05 ms.

5. The method according to claim 1, wherein the pre-opening signal is a voltage signal which comprises a predetermined pre-opening voltage.

6. The method according to claim 5, wherein the opening signal is another voltage signal which comprises a predetermined opening voltage.

7. The method according to claim 6 wherein the predetermined opening voltage is higher or lower than the predetermined pre-opening voltage.

8. The method according to claim 6, wherein the predetermined pre-opening voltage is at most half of the predetermined opening voltage, or the predetermined pre-opening voltage is at least twice the predetermined opening voltage.

9. The method according to claim 1, wherein the pre-opening signal is a continuous signal.

10. The method according to claim 1, wherein the pre-opening signal is a continuous voltage signal.

11. The method according to claim 1, wherein the pre-opening signal is a pulse-like signal, which comprises one or more signal pulses.

12. The method according to claim 11, wherein the pre-opening signal is a voltage signal.

13. The method according to claim 1, wherein the at least one valve comprises a solenoid valve.

14. The method according to claim 1, wherein the spraying agent comprises a release agent.

15. The method according to claim 1, wherein an opening time of the at least one valve for discharging a spray burst of the spraying agent is at most 7 ms.

16. The method according to claim 1, wherein an opening time of the at least one valve for discharging a spray burst of the spraying agent is at most 5 ms.

17. The method according to claim 1, wherein an opening time of the at least one valve for discharging a spray burst of the spraying agent is at most 3 ms.

18. A slicing machine comprising:
a feeding unit, which is configured to feed at least one product caliber along a feed direction;
a slicing unit, which is configured to slice into slices the at least one product caliber fed by the feeding unit;
a spraying device with at least one valve, which is configured to discharge a spraying agent towards the at least one product caliber and/or onto at least one of the sliced slices; and
a control unit, which is in signal connection with at least the spraying device and configured to send an opening signal to the spraying device thereby causing the discharge of the spraying agent, wherein the control unit is further configured to send a pre-opening signal before the opening signal to the spraying device, and wherein the pre-opening signal itself does not yet cause any discharge of the spraying agent by the spraying device.
